(19) United States
(12) Patent Application Publication
(10) Pub. No.: US 2026/0150069 A1
(43) Pub. Date: May 28, 2026

(54) METHOD FOR PROVIDING AND FINDING USER-SPECIFIC INFORMATION

(71) Applicant: Daniel FEYERLEIN, Hilpoltstein (DE)

(72) Inventor: Daniel FEYERLEIN, Hilpoltstein (DE)

(21) Appl. No.: 19/396,691

(22) Filed: Nov. 21, 2025

(30) Foreign Application Priority Data
Nov. 21, 2024 (DE) 10 2024 134 242.0

(51) Int. Cl. H04W 60/00

(52) U.S. Cl. CPC H04W 60/00

(57) ABSTRACT

The invention relates to providing and retrieving user-specific information (104) within a defined, short range. This technology is based on the interaction of three components. These are: a mobile transmitting device (2) of a first user (4) including a transmitting unit (6) in the form of a BLE beacon for transmitting an identifier (101); user-specific information (104) associated with the identifier (101), for example a user profile of the first user (4); and a receiving device (3) of a second user (5), preferably a smartphone, including a receiving unit (7) configured to receive the identifier (101) transmitted by the mobile transmitting device (2), said receiving device (3) being configured to acquire and output the user-specific information (104) associated with the received identifier (101) to the second user (5), wherein this functionality is preferably provided to the receiving device (3) by means of a smartphone app (8) programmed in a suitable manner.

### FIELD

The invention relates to a method for providing and retrieving user-specific information. In addition, the invention relates to a mobile transmitting device and a mobile receiving device. Additionally, the invention relates to a system comprising a mobile transmitting device and a mobile receiving device.

### BACKGROUND

People often desire to obtain information about other people located in their vicinity or to obtain information about activities of such people. This is often the case, when people move about outside of their home or place of work, are traveling, for example, or engage in leisure activities, because in these cases, it is highly probable that they are in the vicinity of other people they do not know.

On the other hand, people often desire to share information about themselves or their activities with other people in their vicinity.

In practice, the problem is that both those interested in obtaining information as well as those interested in sharing information are not aware of each other. The members of said first group of people can only assume that there are members of said second group of people who are currently in their vicinity, and vice versa. In such a situation it is often inappropriate to share information with other people without being asked or, conversely, to ask other people for such information.

### SUMMARY

It is an object of the present invention to provide a technique for providing and retrieving user-specific information that remedies this situation.

This object is achieved by the subject matter of the independent claims. Advantageous embodiments of the invention are provided in the dependent claims or become apparent from the following description and/or the accompanying figures.

The advantages and embodiments explained below in the context of the method also apply correspondingly to the devices and the system according to the invention, respectively, and vice versa.

The invention enables providing and retrieving user-specific information within a defined, short range. The invention allows, on one hand, providing personalized information in a simple and inconspicuous manner, and on the other hand obtaining such information in a simple and inconspicuous manner. The invention provides the means for communicatively connecting individual members of the aforementioned groups of people on demand, namely, users providing information on the one hand, and users searching for information on the other hand.

In other words, on one hand, it becomes easier for people who wish to provide information about themselves or their activities to do so without troubling other people who are not interested in this information. The invention helps people to communicate information about themselves and their activities to others in their immediate vicinity.

On the other hand, it becomes easier for people who wish to obtain information about other people or their activities to do so without first having to establish personal contact with the other person. In particular, the invention allows these people to predicate on the obtained information, whether they wish to establish personal contact with the other person. In this way, the invention helps people to recognize opportunities to get to know other people located in their vicinity and their activities. The invention helps people to find and obtain useful information relating to their immediate vicinity about people or their activities.

The invention is particularly versatile in its application. In particular, providing and retrieving information is not limited to people. Rather, the invention may be used in general for providing and retrieving any user-specific information of any type of user. In other words, not only individuals are considered to be users, in particular first users, but also objects. In principle, any mobile or immobile object may function as a first user.

The following first examines and describes the method in its entirety.

The method according to the invention for providing and retrieving user-specific information comprises the following steps of: an identifier assigned to a transmitting unit of a mobile transmitting device of a first user is registered in a registration database and associated with user-specific information of the first user; the identifier is transmitted by the transmitting unit; the identifier transmitted by the transmitting unit is received by a receiving unit of a mobile receiving device of a second user, the receiving unit being located within range of the transmitting unit; the user-specific information associated with the received identifier is acquired and output to the second user. Here, the transmitting unit is a BLE (Bluetooth Low Energy) beacon and the identifier of the transmitting unit is a universally unique identifier (UUID).

According to a preferred embodiment of the invention, the UUID identifier is embodied as a unique designation of the transmitting unit. For this purpose, the UUID comprises a hardware-based identifier of the BLE beacon, in particular a device address of the BLE beacon, according to a preferred embodiment of the invention. In particular, the UUID comprises the Bluetooth device address of the BLE beacon, hereinafter referred to as a MAC address. In particular, the UUID comprises the hardware-based public device address as a fixed, immutable Bluetooth device address.

According to a preferred embodiment of the invention, all mobile transmitting devices of the system according to the invention are equipped with transmitting units whose UUIDs are partially identical. Preferably, all UUID are assigned to a single company, namely the manufacturer of the transmitting units and/or the system operator.

According to a preferred embodiment of the invention, all UUIDs compatible with the system according to the invention comprise an identical, predefined portion and a variable portion. The predefined portion enables checking whether a particular UUID belongs to a particular UUID group, that is, to the UUID group of transmitting units of the mobile transmitting devices used with the system according to the invention.

According to a preferred embodiment of the invention, a UUID is stored in each transmitting unit used with the system according to the invention, the UUID including a first portion, identical for all transmitting units of the system, and a second hardware-specific portion, namely the MAC address of the transmitting unit. This is particularly easy to implement if the transmitting units are components of dedicated mobile transmitting devices and their MAC addresses are known during the manufacture of the mobile transmitting devices. This storing of a UUID specific to the system according to the invention in the transmitting is done preferably in connection with the manufacture of the transmitting unit or during a subsequent initialization of the transmitting unit. Alternatively, said storing may also be done during a later initial UUID assignment or during a new or additional UUID assignment.

According to a preferred embodiment of the invention, the MAC addresses of the transmitting units are printed on the mobile transmitting devices and/or may easily be determined by a user in another manner, for example read from a data storage of the transmitting device.

According to a preferred embodiment of the invention, the registering of the identifier, assigned to the transmitting unit of the mobile transmitting device of a first user, in the registry database (identifier database) includes storing (saving) the identifier in the database.

However, according to a preferred embodiment of the invention, it is not necessary to specify the entire UUID for registering the identifier in the database. Preferably, the registration entity knows the MAC addresses of all transmitting units that have been installed in manufactured or sold transmitting devices. For example, these MAC addresses are already stored in the registration database. Then, in order to register the identifier of a single transmitting unit, it is only necessary to indicate the MAC address of the transmitting unit. The registration entity subsequently checks whether the specified MAC address is an already stored MAC address. If this is the case, the corresponding UUID is created by the registration entity and acknowledged and registered as a valid and active identifier.

Alternatively, according to an embodiment of the invention, it may be necessary to input the entire UUID into the registration database during registration. In particular, this is the case, if the hardware-based identifier of the BLE beacon (device address) is not known to the first user and/or the registration entity, for example, because the mobile transmitting device is not dedicated hardware, but rather a general Bluetooth-capable device.

According to a preferred embodiment of the invention, the registration is done by the manufacturer of the transmitting unit, by the vendor of the transmitting unit, or by the first user.

According to a preferred embodiment of the invention, the registration is carried out on a registration platform that can be accessed over the Internet.

According to a preferred embodiment of the invention, the identifier is associated with user-specific information of the first user, in particular with personalized information of the first user, by the first user.

According to a preferred embodiment of the invention, the user-specific information includes a user profile of the first user, in particular a user profile presented on a website, and/or personalized information of the first user's person, such as contact information or personal messages.

According to a preferred embodiment of the invention, the user-specific information is selected and/or provided by the first user.

According to a preferred embodiment of the invention, the association is carried out by storing access or address information (e.g. an Internet URL) with the identifier in the registration database for accessing the user-specific information. The user-specific information itself is preferably stored in a second database (information database) or at a storage location on the Internet.

According to a preferred embodiment of the invention, the registration database is a database that is installed as a software application on a physical device, whereby this physical device is neither the mobile transmitting device nor the mobile receiving device. Rather, the data of the registration database is stored at a third location.

According to a preferred embodiment of the invention, the identifier of the transmitting unit of the mobile transmitting device of the first user is transmitted to a receiving unit of a mobile receiving device of a second user. More specifically, the identifier is transmitted by the transmitting unit and received by the mobile receiving device, if this receiving unit is within the transmission range of the transmitting unit.

According to a preferred embodiment of the invention, the identifier transmitted by the transmitting unit of the mobile transmitting device of the first user is received by the receiving unit of the mobile receiving device of the second user who is located within the locally limited range of the transmitting unit. In other words, only receivers located within the locally limited range of the transmitting unit of the mobile transmitting device, that is, within its immediate vicinity, are able to receive the identifier. Here, the range depends on the transmission technology used by the transmitting unit. The method is therefore a method for providing and retrieving user-specific information in a range-limited manner. Due to the use of a BLE (Bluetooth Low Energy) beacon as the transmitting unit of the mobile transmitting device, the range is limited to 150 m. This represents a fundamental property of the method according to the invention and provides a particular advantage for the idented use of the method, because this avoids that the recipient obtains information that is not relevant to him or her at his or her present location.

According to a preferred embodiment of the invention, the user-specific information associated with the received identifier is acquired (e.g. retrieved from the Internet) and provided to the second user (e.g. saved or displayed on the second user's device) by checking in a first step whether the received identifier is a) registered in the registration database and b) associated with user-specific information of a first user. This check is carried out using suitable data processing and communication means, preferably using the smartphone of the second user as well as the Internet. In a subsequent second step, this information is provided to the second user in a suitable manner, for this purpose said information is transmitted and/or stored on the smartphone of the second user in particular via the Internet, for example, in order to be displayed on the screen of the smartphone.

According to a preferred embodiment of the invention, the mobile transmitting device with the transmitting unit is attachable and/or attached to an object or person. The transmitting device is personalized in this manner, that is, linked to a specific person or a specific object and associated, in terms of content and function, not only physically, but also via the user-specific information associated with the transmitting device.

According to the invention, the transmitting unit of the mobile transmitting device is a range-limited transmitting unit for wireless data transmission, that is, a BLE (Bluetooth Low Energy) beacon. In other words, the transmitting unit is configured to transmit wireless BLE signals. The BLE beacon transmits—preferably continuously—a signal that can be received when a suitable receiver is within range. Due to the limited range of this technology, a locally limited scope is created from the outset. The transmitting unit has a locally limited range. Preferably, the range of the transmitting unit is at most 150 meters. This way, the functionality of the technology according to the invention is deliberately limited to the immediate surroundings of the participating users.

According to a preferred embodiment of the invention, it is provided that the transmitting unit is configured such that the maximum range of the transmitted signals may be changed, in particular adjusted, by the first user. Preferably, a mechanism for adjusting the transmitting power of the employed wireless transmitter is provided for this purpose. The transmitting power of the transmitting unit may, for example, be changed, in particular adjusted, via a remote control that is embodied as a smartphone app on the smartphone of the first user. In this manner, the first user is able to change the range of his or her transmitting device, in particular to adjust it to his or her desired range. In particular, the first user may limit this range, in order to limit the size of the local scope and thereby the circle of potential second users.

According to a preferred embodiment of the invention, the mobile transmitting device is dedicated hardware that exclusively performs the function of the mobile transmitting device. In this case, in addition to the BLE beacon as transmitting unit, the mobile transmitting device comprises only a power source or connectivity to a power source, as well as optional communication interfaces for a remote control and controls, such as an on/off switch, if the transmitting device is not exclusively operable via a remote control. Alternatively, hardware components internal to the smartphone are used for providing the functionality of the transmitting unit, such that the mobile transmitting device is provided by a smartphone of the first user. This is possible when the smartphone includes a transmitting unit internal to the smartphone that is configured to transmit wireless BLE signals.

According to a preferred embodiment of the invention, the transmitting unit of the mobile transmitting device is transmitting an identifier continuously, that is, nonstop and without pause, the identifier being receivable by a suitable receiving unit within range of the transmitting unit. Alternatively, the transmitting unit does not continuously transmit the identifier, but rather in time intervals, that is, temporarily or only intermittently. In this case, in order to reach the group of recipients desired by the first user, the transmission occurs at short intervals, for example at intervals of a few seconds.

According to a preferred embodiment of the invention, the mobile receiving device is a smartphone. Preferably, the receiving unit of the mobile receiving device is then a receiving unit internal to the smartphone that is configured to receive wireless BLE signals.

According to a preferred embodiment of the invention, the smartphone-internal receiving unit comprises hardware and software components, in particular a smartphone app, that is configured to search for and receive wireless signals of a BLE beacon.

According to a preferred embodiment of the invention, the mobile receiving device or a portion thereof, in particular the smartphone app, is simultaneously configured to acquire (e.g. retrieve from the Internet) and/or output (e.g. display, transmit, . . . ) the user-specific information associated with the received identifier.

According to a preferred embodiment of the invention, the first user and/or the second user are moving during the transmission or receipt, respectively, of the identifier.

If the first user is moving, the number of second users receiving user-specific information of the first user may change. According to a preferred embodiment of the invention, it is provided to provide the first user with statistical information for utilizing the user-specific information, in particular information on retrieval frequency of the user-specific information, for example using functionality of the registration database.

If the second user is moving in a different way compared to the first user, the receiving unit leaves the range of the transmitting unit sooner or later. According to a preferred embodiment of the invention, using functionality of the receiving device, it is displayed to the second user that the transmitting device of the first user has moved outside of the search range.

According to a preferred embodiment of the invention, the first user and/or the second user are natural persons provided with the possibility of interaction over short distances in this manner. However, an object may also be a first user. This results in a variety of possible applications. For example, in this way, passers-by may obtain additional information about the work of a street artist and the person of the artist. At events, attendees may be provided with current information about the agenda. At trade shows, attendees may obtain current business information and advertising material of the exhibitors. In stores, customers may discover goods and services offered. In the auto-tuning sector, pedestrians or motorists may obtain information about the sighted vehicle and its driver. At construction sites, pedestrians may obtain information about the construction project. During guided tours of museums, city walks or city tours or the like, information may specifically be provided or retrieved as well. Restaurants may communicate their menus and specials, and much more.

According to a preferred embodiment of the invention, the transmission of the identifier by the transmitting unit may be turned on and off by the first user. In other words, the first user may decide whether the transmitting unit of the transmitting device is transmitting the identifier.

According to a preferred embodiment of the invention, one or more of the receipt of the identifier by the receiving unit of the mobile receiving device, the acquisition, and the output of the user-specific information associated with the received identifier are dependent on prior registration of one or more of the receiving unit, the mobile receiving device, and the second user in a recipient database. In other words, only registered receiving units or registered mobile receiving devices or registered second users, respectively, are allowed to receive identifiers, and acquire and/or output information, respectively. In an alternative embodiment, registration is not necessary for this and identifiers are received, and information is acquired and/or output, respectively, whenever an identifier is received.

According to a preferred embodiment of the invention, the quantitative and/or qualitative scope of the user-specific information that is acquired and/or output after receipt of the identifier by the receiving unit of the mobile receiving device depends on prior registration of at least one of the receiving unit, the mobile receiving device, and the second user in a recipient database. In other words, it may be made dependent on such a registration, which user-specific information the second user is able to acquire or output. For example, it may be provided that simple information, such as a name or a designation of a first user is always provided, that is, without prior registration of the second user, while further information, such as contact and address information, may be provided to the second user only after registration has taken place.

According to a preferred embodiment of the invention, on the one hand, the receipt of the identifier by the receiving unit of the mobile receiving device and/or, on the other hand, the acquisition and/or output of the user-specific information associated with the received identifier may be turned on and off by the second user. In other words, the second user may decide whether to enable the basic functionality of the method, that is, whether the receiving unit receives the identifier, and whether the information is acquired and/or output. In a simple case, the mobile receiving device is a smartphone with a processor on which a smartphone app for receiving and/or processing identifiers is executed. The second user may then turn the functionality according to the invention on and off by starting and terminating the app, respectively.

According to a preferred embodiment of the invention, the mobile receiving device is configured such that the second user is able to selectively acquire and/or output user-specific information in terms of type, scope, and/or content. For example, the second user is able to select, by means of suitable selection means, whether information from the areas culture (for example, about upcoming or ongoing cultural events in his or her vicinity), restaurants (e.g. menus of restaurants in his or her vicinity) and/or retail (e.g. promotions by vendors in his or her vicinity) is to be acquired and output. Providing such a selection or filtering functionality according to categories or other criteria may advantageously be made dependent on prior registration of the second user.

According to a preferred embodiment of the invention, on the one hand, the receipt of the identifier by the receiving unit of the mobile receiving device and/or, on the other hand, the acquisition and/or output of the user-specific information associated with the received identifier may occur automatically. In an alternative embodiment, user-specific information associated with the received identifier is only output at the request of the second user. In other words, it is provided that, even when the functionality for receiving and acquiring the information is enabled, it is only output at the request of the second user. Such a request/retrieval functionality on the part of the second user may advantageously be combined with the selection or filter functionality described above, in order to increase the benefit for the second user.

In the following, the method is considered from the perspective of the first user, that is, the transmitter. This primarily refers to providing information to third parties that are located in close proximity to the transmitting device. The method for providing information by operating a mobile transmitting device according to the invention comprises the following steps of: registering an identifier (UUID), assigned to a transmitting unit of a mobile transmitting device of a first user, in a registration database, and associating the identifier with user-specific information of the first user; transmitting the identifier by the transmitting unit (BLE beacon) to a receiving unit of a mobile receiving device of a second user, in order to enable the mobile receiving device to receive the identifier by means of the receiving unit, and to acquire and/or to output the user-specific information associated with the received identifier to the second user.

The following describes the mobile transmitting device used on the part of the first user. The mobile transmitting device of a first user according to the invention comprises a transmitting unit (BLE beacon) configured to transmit an identifier (UUID), assigned to the transmitting unit and registered in a registration database and associated with user-specific information of the first user, to a receiving unit of a mobile receiving device, in order to enable the mobile receiving device to receive the identifier by means of the receiving unit, and to acquire and/or output the user-specific information to the second user.

According to a preferred embodiment of the invention, in the simplest case, the transmitting device includes merely the transmitting unit and means for electrically powering the transmitting unit, for example, a battery. The transmitting unit and the battery may be arranged in a housing. The housing may include attachment means for attaching the transmitting device to an object or a person.

In the following, the method is considered from the perspective of the second user, that is, the recipient. This primarily refers to retrieving information of third parties that are located in close proximity to the receiving device. The method for retrieving information by operating a mobile receiving device comprises the following steps of: receiving an identifier (UUID), transmitted by a transmitting unit (BLE beacon) of a mobile transmitting device of a first user, by means of a receiving unit of a mobile receiving device of a second user, the identifier being assigned to the transmitting unit, registered in a registration database, and associated with user-specific information of the first user; acquiring and outputting the user-specific information associated with the received identifier to the second user.

According to a preferred embodiment of the invention, the acquiring and/or outputting the information is carried out by the second receiving device or using the second receiving device.

The following describes the mobile receiving device used on the part of the second user. The mobile receiving device of a second user according to the invention comprises a receiving unit, configured to receive an identifier (UUID) transmitted by a mobile transmitting device of a first user, the identifier being assigned to the transmitting unit, registered in a registration database, and associated with user-specific information of the first user, in order to allow acquiring and/or outputting the user-specific information to the second user.

According to a preferred embodiment of the invention, the mobile receiving device includes a processing unit configured to acquire and/or output the user-specific information.

The following describes a computer program used on the part of the second user. The computer program according to the invention comprises instructions, which, when the program is executed by a computer, cause the computer to acquire and/or output, to a second user, user-specific information of a first user associated with an identifier (UUID), whereby said identifier was transmitted by a transmitting unit (BLE beacon) of a mobile transmitting device of the first user and received by a receiving unit of a mobile receiving device of the second user, the identifier being assigned to the transmitting unit, registered in a registration database, and associated with user-specific information of the first user. Preferably, the receiving device is connected to the computer or (an integral) part of the computer.

According to a preferred embodiment of the invention, this computer program comprises instructions, which, when the program is executed by a computer, cause said computer to receive the identifier, transmitted by the transmitting unit of the mobile transmitting device of the first user, by means of the receiving unit of the receiving device of the second user.

According to a preferred embodiment of the invention, this computer program is a smartphone app.

A system according to the invention for carrying out the method according to the invention comprises a mobile transmitting device as described above, and a mobile receiving device as described above.

According to a preferred embodiment of the invention, the technology is based on the interaction of three components. These are: a mobile transmitting device of a first user including a transmitting unit in the form of a BLE beacon for transmitting an identifier in the form of a UUID, the mobile transmitting device preferably being attachable to a person or to an object; user-specific information associated with the identifier, for example a personalized profile of the first user on a website; and a receiving device of a second user, preferably a smartphone, including a receiving unit configured to receive the identifier transmitted by the mobile transmitting device, said receiving device being configured to acquire and output the user-specific information associated with the received identifier, this functionality of the receiving device preferably being provided by a smartphone app programmed in a suitable manner. In other words, when utilizing this technology, the smartphone app being executed serves as search software for searching for identifiers usable in a manner according to the invention that are being transmitted by transmitting devices located nearby.

Due to the use of BLE beacons as transmitting units, scenarios are contemplated, where a receiving unit, depending on its location, constantly receives multiple identifiers. From the plurality of signals received by the receiving unit, those identifiers that are registered in the registration database according to the invention and associated with user-specific information are then selected by the receiving device. All other received identifiers, in particular wireless signals from other wireless BLE devices, such as household appliances and the like, are ignored, because these are not registered in the registration database.

To a large extent, the method according to the invention may be carried out with the help of computers. The devices suitable for carrying out the method according to the invention can be substantially realized, at least on the part of the second user, by providing a suitable computer program (smartphone app). For this purpose, an expensive modification of the hardware is not necessarily required, provided that a device, for example a smartphone, is used that already includes a suitable receiving unit. Preferably, the computing unit for executing the computer program is a processor of the smartphone.

### DESCRIPTION OF THE FIGURE

FIG. 1 is a schematic view of a system comprising a mobile transmitting device and a mobile receiving device.

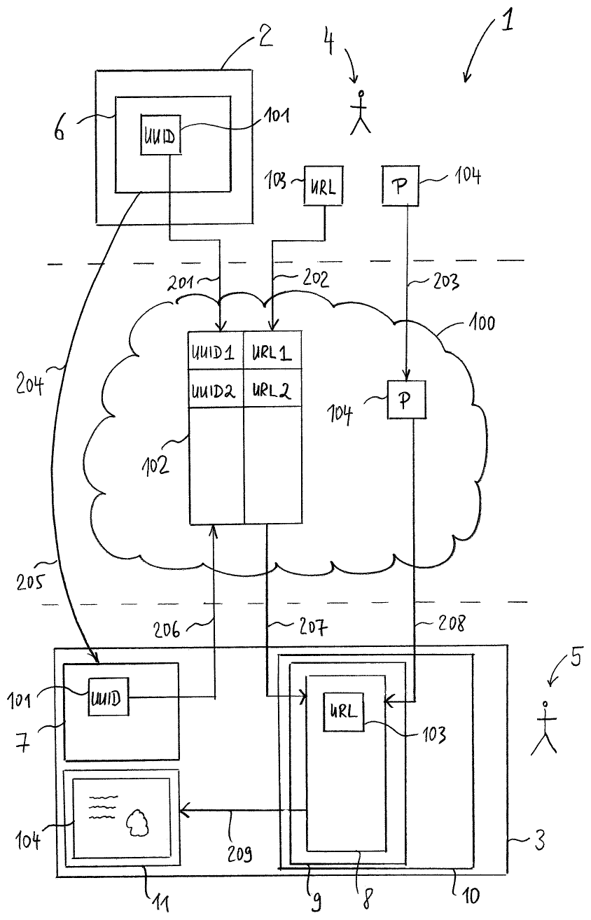

### DETAILED DESCRIPTION

An example embodiment of the invention will be explained below in more detail with reference to the drawings. Therein, the sole figure shows a schematic representation of a system 1 including a mobile transmitting device 2 and a mobile receiving device 3 that operate in accordance with the method according to the invention. The figure illustrates the invention merely schematically and only with its essential components.

First, the domain of the first user 4 and the range-limited provision of information will be described. A person as a first user 4 uses the mobile transmitting device 2 having a BLE beacon as a transmitting unit 6 and registers (registration step 201), using a registration platform (not illustrated) on the Internet 100, an identifier 101 in the form of the UUID identifier of the beacon 6 in a registration database 102 on the Internet 100.

The 128-bit UUIDs of all transmitting units 6 usable with the system 1 have the format 8-4-4-4-12 and comprise 32 hexadecimal characters, divided into five groups by means of hyphens, that is, represented as yyyyyyyy-yyyy-yyyy-yyyy-xxxxxxxxxxxx. For the UUIDs used herein, the first UUID portion yyyyyyyy-yyyy-yyyy-yyyy is identical for all transmitting units 6. In particular, this is an address specific to the manufacturer or the system operator. The second UUID portion xxxxxxxxxxxx with a length of 48 bits is the MAC address of the specific transmitting unit 6, to which the UUID is assigned. The full 128-bit UUIDs of the transmitting units 6 are assigned to the transmitting units 6 prior to their first use, preferably during the manufacture of the mobile transmitting devices 2 and using the known MAC addresses of the transmitting units 6. The registration of the identifier 101 (UUID) in the registration database 102 is then carried out, such that the first user 4 only needs to enter the MAC address of the BLE beacon 6 into the registration database 102. Because the MAC address is typically printed on the device as a hardware identifier or may be read from the device in a comparatively simple manner, knowledge of the full UUID is not required for carrying out the registration step 201. If the MAC address entered during registration is an already known, stored MAC address, this MAC address is completed into a UUID and registered as the identifier 101. In this way, the registration can be performed particularly quickly, easily, and accurately.

In addition, the first user 4 associates (association step 202) the UUID 101 with user-specific information 104 by storing an Internet URL as address information 103 in the registration database 102 for accessing a website, where the first user 4 has stored user-specific information (storage step 203), for example in the form of a user profile 104. The user-specific information 104 may also be associated with the identifier 101 in another manner; in particular, the user-specific information 104 may also be stored directly in the registration database 102.

The first user 4 is a street artist. He or she carries the mobile transmitting device 2, for example on his or her clothing. After the first user 4 activates the BLE beacon 6, said beacon automatically transmits the identifier 101 using BLE technology (transmission step 204). Thereby the range of the employed BLE beacon 6 is, for example, 20 meters.

In the following, the domain of the second user 5 and the range-limited retrieving of information will be described. A person as the second user 5 utilizes a mobile receiving device 3 in the form of a smartphone that they carry with them. The second user 5 is a pedestrian located in the vicinity of the first user 4 viewing a work of art created by the first user 4, for example. The receiving unit 7 of the smartphone 3 is configured to receive wireless BLE signals, scans the corresponding frequency range, and automatically receives the identifier 101 transmitted by the transmitting unit 6 when the smartphone 3 of the second user 5 is within the transmission range of the transmitting unit 6 (reception step 205).

Subsequently, receiving device 3 software (a smartphone app) 8 working in conjunction with the receiving unit 7 automatically checks, using the data transmission means of the smartphone 3, whether the received identifier 101 is registered in the registration database 102 and associated with user-specific information 104 (first query step 206). It may be provided that the querying of the registration database 102 by the smartphone app 8 is conditioned upon prior registration of the smartphone app 8 in a recipient database (not shown) by the second user 5.

In the present case, an Internet URL is stored as address or access information 103 in the registration database 102 with the UUID 101 of the BLE beacon 6. The smartphone app 8 retrieves the Internet URL 103 from the registration database 102 (second query step 207) and downloads the corresponding user profile 104 from the Internet 100 into the memory 9 of the smartphone 3 (acquisition step 208) for subsequently displaying the user profile 104 on the display 11 of the smartphone 3 (output step 209). Preferably, the second user 5 is notified by acoustic and/or visual means that information 104 has been obtained and/or output. The data processing steps that are to be performed by the smartphone 3 in connection with the method, including executing the smartphone app 8, are carried out in a processing unit 10 of the smartphone 3 comprising at least one processor (not illustrated), and comprising and/or being connected to the memory 9 of the smartphone 3.

In a modified variant, there is a user-specific identifier (not shown) stored by the first user 4 in the registration database 102. In other words, the first user 4 registers with the registration entity with a user ID. In this way, the identifier 101 (the UUID) is primarily associated with the user ID. The user ID is preferably a short, memorable term, typically a user name. In turn, the user ID is associated with the user-specific information 104 (e.g. the user profile) via an Internet URL 103 or in another suitable manner, whereby it may also be provided that the user ID forms a portion of the internet URL 103. Using such a user ID, whether in addition to an Internet URL or instead of an Internet URL, has the advantage that a second user 5 is able to acquire and output the user-specific information 104, even when the receiving device 3 is not within range of the transmitting device 2, provided the user ID is known to the second user and he or she obtains access to the information 104 using the user ID.

All the features shown in the description, the following claims, and the drawings may be essential to the invention both individually and in any combination with one another. These features or combinations of features may each constitute an independent invention, the claim of which is expressly reserved.

When specifying a combination of features defining an invention, individual features from the description of an embodiment example do not necessarily have to be combined with one or more or all other features specified in the description of this embodiment example; in this respect, each subcombination of features of one or more example embodiments is expressly disclosed.

In addition, the material features of the device may be restated for use as method features and method features can be restated for use as material features of the device. Features restated in this manner are disclosed implicitly.

The registration entity used during registration is provided by a traditional data processing unit, if necessary adapted to the particularities of the described method.

The devices 2, 3 according to the invention are configured to perform the described method. Preferably, a portion of the mobile receiving device 3 is a data processing unit 10 that is configured to carry out all steps according to the method described herein that are associated with the processing of data on the part of the second user. Thereby, the data processing unit is in operative connection with an antenna of the receiving device 3 and other signal transmission devices, in order to process, to store, and/or to display the received signal of the transmitting unit 6 and the obtained information 101, 103, respectively.

The aforementioned data processing units preferably comprise a number of function modules, each function module being configured to carry out a specific function or a number of specific functions in accordance with the described method. The function modules may be hardware modules or software modules. In other words, the invention, as far as data processing units are concerned, may be realized either in the form of computer hardware or in the form of computer software or in a combination of hardware and software. To the extent that the invention is realized in the form of software, that is, as a computer program, all corresponding functions are realized by computer program instructions when the computer program is executed on a computer with a processor. The computer program instructions are thereby realized in a manner known per se in any programming language and may be provided to the computer in any form, for example, in the form of data packets transmitted over a computer network, or in the form of a computer program stored on a floppy disk, a CD-ROM, or another data storage medium.

The present invention claims protection for, among other things, the methods, devices, and systems specified below.

A method for providing and retrieving user-specific information 104, comprising the steps of:
an identifier 101 assigned to a transmitting unit 6 of a mobile transmitting device 2 of a first user 4 is registered in a registration database 102 and associated with user-specific information 104 of the first user 4, the identifier 101 being a universally unique identifier (UUID),
the identifier 101 is transmitted by the transmitting unit 6, the transmitting unit 6 of the mobile transmitting device 2 being a BLE (Bluetooth Low Energy) beacon,
the identifier 101 transmitted by the transmitting unit 6 is received by a receiving unit 7 of a mobile receiving device 3 of a second user 5, the receiving unit being located within range of the transmitting unit 6,
the user-specific information associated with the received identifier is acquired and output to the second user.

The method as specified above, wherein the identifier 101 comprises the MAC address of the transmitting unit 6.

The method as specified above, wherein the mobile receiving device 3 is a smartphone.

The method as specified above, wherein said transmitting of the identifier 101 can be switched on and off by the first user 4 via the transmitting unit 6.

A method for providing information by operating a mobile transmitting device 2, comprising the steps of:
registering an identifier 101, assigned to a transmitting unit 6 of the mobile transmitting device 2 of a first user 4, in a registration database 102, and associating the identifier 101 with user-specific information 104 of the first user 4, the identifier 101 being a universally unique identifier (UUID),
transmitting the identifier 101 by the transmitting unit 6, the transmitting unit 6 of the mobile transmitting device 2 being a BLE (Bluetooth Low Energy) beacon, to a receiving unit 7 of a mobile receiving device 3 of a second user 5, in order to enable the mobile receiving device 3 to receive the identifier 101 by means of the receiving unit 7, and to acquire and/or to output the user-specific information 104 to the second user 5.

A mobile transmitting device 2 having a transmitting unit 6, the transmitting unit 6 being a BLE (Bluetooth Low Energy) beacon, configured to transmit an identifier 101, assigned to the transmitting unit 6 and registered in a registration database 102 and associated with user-specific information 104 of a first user 4, to a receiving unit 7 of a mobile receiving device 3 of a second user 5, in order to enable the mobile receiving device 3 to receive the identifier 101 by means of the receiving unit 7, and to acquire and/or output the user-specific information 104 to the second user 5, wherein the identifier 101 is a universally unique identifier (UUID).

Using a mobile transmitting device 2 including a transmitting unit 6, the transmitting unit 6 being a BLE (Bluetooth Low Energy) beacon, configured to transmit an identifier 101, assigned to the transmitting unit 6 and registered in a registration database 102 and associated with user-specific information 104 of a first user 4, to a receiving unit 7 of a mobile receiving device 3 of a second user 5, in order to enable the mobile receiving device 3 to receive the identifier 101 by means of the receiving unit 7, and to acquire and/or output the user-specific information 104 to the second user 5, wherein the identifier 101 is a universally unique identifier (UUID).

A method for retrieving information 104 by operating a mobile receiving device 3, comprising the steps of:
receiving an identifier 101, transmitted by a transmitting unit 6 of a mobile transmitting device 2 of a first user 4, by a receiving unit 7 of a mobile receiving device 3 of a second user 5, the identifier 101 being assigned to the transmitting unit 6, registered in a registration database 102, and associated with user-specific information 104 of the first user 4, wherein the transmitting unit 6 of the mobile transmitting device 2 is a BLE (Bluetooth Low Energy) beacon, and wherein the identifier 101 is a universally unique identifier (UUID),
acquiring and/or outputting the user-specific information 104 to the second user 5.

A mobile receiving device 3 including a receiving unit 7, configured to receive an identifier 101 transmitted by a transmitting unit 6 of a mobile transmitting device 2 of a first user 4, wherein the transmitting unit 6 of the mobile transmitting device 2 is a BLE (Bluetooth Low Energy) beacon, and wherein the identifier 101 is a universally unique identifier (UUID), wherein the identifier 101 is assigned to the transmitting unit 6, registered in a registration database 102, and associated with user-specific information 104 of the first user 4, in order to enable acquiring and/or outputting the user-specific information 104 to the second user 5.

The mobile receiving device 3 as specified above, including a processing unit 10, configured to acquire and/or output the user-specific information 104 associated with the received identifier 101.

Using a mobile receiving device 3 including a receiving unit 7, configured to receive an identifier 101 transmitted by a transmitting unit 6 of a mobile transmitting device 2 of a first user 4, wherein the transmitting unit 6 of the mobile transmitting device 2 is a BLE (Bluetooth Low Energy) beacon, and wherein the identifier 101 is a universally unique identifier (UUID), wherein the identifier 101 is assigned to the transmitting unit 6, registered in a registration database 102, and associated with user-specific information 104 of the first user 4, in order to enable acquiring and/or outputting the user-specific information 104 to the second user 5.

A computer program 8, comprising instructions, which, when the program is executed by a computer 3, cause said computer to acquire and/or output user-specific information 104 of a first user 4, said information 104 being associated with an identifier 101, wherein the identifier 101 is a universally unique identifier (UUID), the identifier 101 is transmitted by a transmitting unit 6 of a mobile transmitting device 2 of the first user 4 and received by a receiving unit 7 of a mobile receiving device 3 of a second user 5, wherein the transmitting unit 6 of the mobile transmitting device 2 is a BLE (Bluetooth Low Energy) beacon, the identifier 101 is assigned to the transmitting unit 6, registered in a registration database 102, and associated with user-specific information 104 of the first user 4.

The computer program 8 as specified above, comprising instructions, which, when the program is executed by a computer 3, cause said computer to receive the identifier 101 transmitted by the transmitting unit 6 of the mobile transmitting device 2 of the first user 4 by means of the receiving unit 7 of the receiving device 3 of the second user 5.

A system 1, comprising a mobile transmitting device 2 as specified above and a mobile receiving device 3 as specified above.

### List of Reference Numerals

1 system
2 mobile transmitting device
3 mobile receiving device
4 first user
5 second user
6 transmitting unit, BLE beacon
7 receiving unit
8 smartphone app
9 smartphone memory
10 processing unit
11 smartphone display
100 Internet
101 identifier, UUID
102 registration database
103 Internet URL
104 user-specific information, user profile
201 registration step
202 association step
203 storage step
204 transmission step
205 reception step
206 first query step
207 second query step
208 acquisition step
209 output step

1. A method for providing and retrieving user-specific information (104), comprising the steps of:
an identifier (101) assigned to a transmitting unit (6) of a mobile transmitting device (2) of a first user (4) is registered in a registration database (102) and associated with user-specific information (104) of the first user (4), the identifier (101) being a universally unique identifier (UUID),
the identifier (101) transmitted by the transmitting unit (6) is received by a receiving unit (7) of a mobile receiving device (3) of a second user (5), the receiving unit being located within range of the transmitting unit (6),
the user-specific information associated with the received identifier is acquired and output to the second user.

2. The method according to claim 1, wherein the identifier (101) comprises the MAC address of the transmitting unit (6).

3. The method according to claim 1, wherein the mobile receiving device (3) is a smartphone.

4. The method according to claim 1, wherein said transmitting of the identifier (101) can be switched on and off by the first user (4) via the transmitting unit (6).

5. A method for providing information by operating a mobile transmitting device (2), comprising the steps of:
registering an identifier (101), assigned to a transmitting unit (6) of the mobile transmitting device (2) of a first user (4), in a registration database (102), and associating the identifier (101) with user-specific information (104) of the first user (4), the identifier (101) being a universally unique identifier (UUID),
transmitting the identifier (101) by the transmitting unit (6), the transmitting unit (6) of the mobile transmitting device (2) being a BLE (Bluetooth Low Energy) beacon, to a receiving unit (7) of a mobile receiving device (3) of a second user (5), in order to enable the mobile receiving device (3) to receive the identifier (101) by means of the receiving unit (7), and to acquire and/or to output the user-specific information (104) to the second user (5).

8. A method for retrieving information (104) by operating a mobile receiving device (3), comprising the steps of:
receiving an identifier (101), transmitted by a transmitting unit (6) of a mobile transmitting device (2) of a first user (4), by a receiving unit (7) of a mobile receiving device (3) of a second user (5), the identifier (101) being assigned to the transmitting unit (6), registered in a registration database (102), and associated with user-specific information (104) of the first user (4), wherein the transmitting unit (6) of the mobile transmitting device (2) is a BLE (Bluetooth Low Energy) beacon, and wherein the identifier (101) is a universally unique identifier (UUID),
acquiring and/or outputting the user-specific information (104) to the second user (5).
